(19) United States
(12) Patent Application Publication
(10) Pub. No.: US 2026/0203663 A1
(43) Pub. Date: Jul. 16, 2026

(54) SYSTEM AND METHOD FOR EMBODIED / OPERATIONAL ALIGNMENT OF HUMAN-ADJACENT ARTIFICIAL INTELLIGENCE SYSTEMS

(71) Applicant: Michel Donald Moore, flemington, NJ (US)

(72) Inventor: Michel Donald Moore, flemington, NJ (US)

(21) Appl. No.: 19/464,560

(22) Filed: Jan. 29, 2026

(51) Int. Cl. G06N 20/00

(52) U.S. Cl. CPC G06N 20/00

(57) ABSTRACT

A system and method are disclosed for embodied and operational alignment of human-adjacent artificial intelligence systems. The disclosed system provides a structured, human-led framework for observing, documenting, and stabilizing alignment between declared human intent, operational context, and observed system behavior during real-world use. The system incorporates human-in-the-loop checkpoints, contextual state capture, and time-bound evaluation surfaces to maintain continuity of intent across system interactions without autonomous enforcement or outcome determination. Alignment is treated as an operational posture expressed through observable signals, documented evidence artifacts, and explicit human confirmation rather than automated decision authority. The method enables alignment evaluation within complex socio-technical environments by embedding interpretive and auditable processes directly into system operation while preserving human responsibility, preventing self-certification, and avoiding autonomous control, judgment, or compliance enforcement.

### FIELD OF THE INVENTION

The present invention relates generally to artificial intelligence systems and, more particularly, to systems and methods for embodied and operational alignment of human-adjacent artificial intelligence systems operating within real-world socio-technical environments.

### BACKGROUND OF THE INVENTION

Artificial intelligence systems are increasingly deployed in close operational proximity to humans, where system behavior, human intent, and environmental context interact continuously. In such human-adjacent deployments, alignment cannot be treated as a static or abstract property, but rather as an operational condition that evolves through interaction, interpretation, and use.

Existing approaches to artificial intelligence alignment frequently emphasize autonomous policy enforcement, internal optimization, or abstract correctness metrics. These approaches may obscure responsibility, introduce implicit authority, or fail to account for embodied context, temporal continuity, and human interpretive judgment.

In many systems, alignment evaluation is decoupled from real-world operation or relegated to post hoc analysis, limiting transparency and auditability. Additionally, alignment mechanisms are often conflated with control, certification, or enforcement, creating ambiguity regarding whether observed alignment reflects human intent or imposed system behavior.

Accordingly, there exists a need for systems and methods that support alignment as an embodied, operational, and human-led process—one that preserves human responsibility, enables traceable evaluation, and avoids autonomous judgment, enforcement, or self-certification by artificial intelligence systems.

### SUMMARY OF THE INVENTION

Disclosed herein are systems and methods for embodied and operational alignment of human-adjacent artificial intelligence systems.

The disclosed system embeds alignment processes directly into system operation through explicit human intent declaration, contextual state capture, observational monitoring, and evidence generation. Alignment is treated as an operational posture expressed through observable signals and documented artifacts rather than automated decisions or enforcement actions.

The system incorporates human-in-the-loop checkpoints requiring explicit confirmation at defined operational stages, thereby preserving human responsibility and interpretive authority. Alignment evaluation is performed without autonomous control, outcome determination, or modification of the artificial intelligence system.

The disclosed methods enable traceable, auditable, and context-aware alignment evaluation within complex socio-technical environments while preventing self-certification, automated authority, or compliance enforcement.

### BRIEF DESCRIPTION OF THE DRAWINGS

The invention may be better understood with reference to the following illustrative, non-limiting drawing:

FIG. 1 illustrates a high-level architecture of a system for embodied and operational alignment.

### DETAILED DESCRIPTION OF THE INVENTION

### 1. System Overview

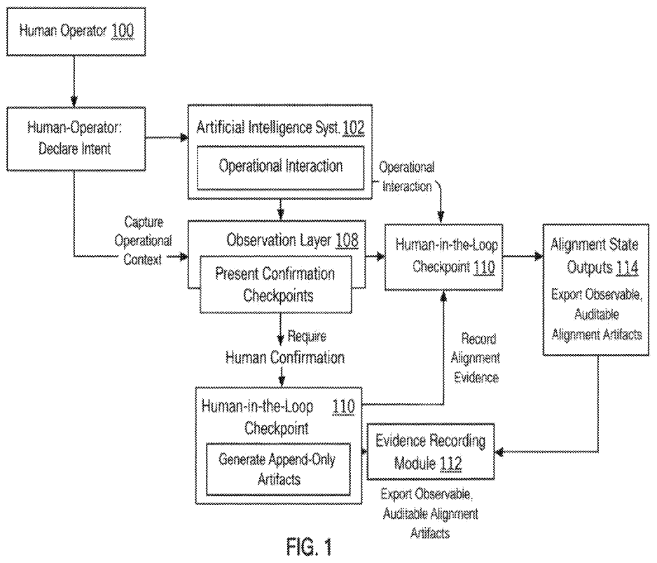

Referring to FIG. 1, a system for embodied and operational alignment comprises a human-operated interface, an artificial intelligence system operating in a human-adjacent role, contextual state capture components, an observation layer, one or more human-in-the-loop checkpoints, and an evidence recording module.

The artificial intelligence system may comprise any model, agent, or composite system and need not expose internal parameters, training data, prompts, or source code to the alignment system.

The alignment system operates alongside the artificial intelligence system and does not impose control, enforcement, or behavioral modification.

### 2. Human Intent Declaration

The human-operated interface is configured to receive an explicit declaration of human intent associated with an operational context. The declaration may include task scope, intended use boundaries, or contextual framing provided by the human operator.

The declared intent informs evaluation and interpretation but does not constrain or modify system behavior.

### 3. Contextual State Capture

Contextual state capture components record operational conditions during system use. Such conditions may include temporal metadata, environmental context, system configuration state, and interaction history.

Captured context provides embodied grounding for alignment evaluation without enabling autonomous inference or enforcement.

### 4. Observation Layer

The observation layer monitors observable behavior of the artificial intelligence system relative to the declared human intent and captured contextual state.

The observation layer documents signals without generating automated judgments, classifications, or determinations.

### 5. Human-in-the-Loop Checkpoints

Human-in-the-loop checkpoints are interposed at defined operational stages and require explicit human confirmation before progression.

These checkpoints ensure that responsibility and interpretive authority remain with the human operator and that alignment evaluation remains human-led.

The human-in-the-loop checkpoints gate continuation of governed operational phases or interface progression and do not modify internal parameters, logic, or behavior of the artificial intelligence system.

### 6. Evidence Recording and Alignment Artifacts

The evidence recording module generates time-stamped, append-only alignment artifacts representing observed behavior, context, and human participation.

Alignment artifacts serve as documentation of operational posture and readiness rather than guarantees, certifications, or approvals.

### 7. Operational Alignment Method

A method for embodied and operational alignment includes:
1. Receiving a declaration of human intent;
2. Capturing contextual state information during system operation;
3. Observing artificial intelligence system behavior;
4. Presenting human confirmation checkpoints; and
5. Recording alignment artifacts without autonomous judgment or enforcement.

Human responsibility for interpretation and action is maintained throughout.

### 8. Boundary Conditions and Non-control Constraint

The disclosed system does not perform certification, authorization, compliance enforcement, or autonomous decision-making. The system does not evaluate ethical merit, correctness, safety, or legality of outcomes.

Any action taken in response to alignment artifacts occurs externally and is not part of the disclosed system.

### 9. Advantages

The disclosed systems and methods provide transparency, traceability, and stabilization of alignment in human-adjacent artificial intelligence deployments while preserving human authority and preventing autonomous enforcement or self-certification.

1. A system for embodied and operational alignment of a human-adjacent artificial intelligence system, comprising:
a human-operated interface configured to receive an explicit declaration of human intent associated with an operational context;
one or more contextual state capture components configured to record operational conditions during interaction between a human and the artificial intelligence system;
an observation layer configured to monitor and document behavior of the artificial intelligence system relative to the declared human intent and the operational context;
one or more human-in-the-loop checkpoints configured to require explicit human confirmation during system operation; and
an evidence recording module configured to generate time-bound, append-only alignment artifacts representing observed system behavior,
wherein the system is configured to evaluate alignment as an operational posture through observable signals and documented evidence without autonomous enforcement, decision authority, or outcome determination.

2. A method for embodied and operational alignment of a human-adjacent artificial intelligence system, comprising:
receiving a declaration of human intent associated with an operational context;
capturing contextual state information during operation of the artificial intelligence system;
observing behavior of the artificial intelligence system relative to the declared human intent and the captured contextual state;
presenting one or more checkpoints requiring explicit human confirmation during system operation;
recording time-stamped alignment artifacts describing observed behavior without assigning automated judgment or enforcement; and
maintaining human responsibility for interpretation and action based on the recorded alignment artifacts.

3. The system of claim 1, wherein the artificial intelligence system operates only in conjunction with explicit human interaction and does not independently initiate alignment determinations.

4. The system of claim 1, wherein the contextual state capture components include temporal, environmental, or operational metadata associated with system use.

5. The system of claim 1, wherein the evidence recording module is configured as an append-only ledger preventing modification of recorded alignment artifacts.

6. The system of claim 1, wherein the human-in-the-loop checkpoints prevent progression of system operation without affirmative human acknowledgment.

7. The system of claim 1, wherein the alignment artifacts are configured to be exportable for external review without enabling system control or modification.

8. The method of claim 2, wherein observing behavior includes documenting drift or coherence relative to the declared human intent without assigning normative evaluation.

9. The method of claim 2, wherein human confirmation is required prior to continuation of an operational phase.

10. The method of claim 2, further comprising presenting alignment artifacts in a human-readable format for reflective evaluation.

11. The method of claim 2, wherein the artificial intelligence system is prevented from generating self-certification, authorization, or compliance determinations.

12. The method of claim 2, wherein the alignment artifacts are retained as evidence of operational posture rather than performance outcome.
